(19) United States
(12) Patent Application Publication
(10) Pub. No.: US 2008/0068213 A1
(43) Pub. Date: Mar. 20, 2008

(54) MANAGING SERIAL NUMBERING OF ENCODER-RECEIVER-TRANSMITTER DEVICES IN AUTOMATIC METER READING SYSTEMS

(76) Inventors: Mark K. Cornwall, Spokane, WA (US); Jeffrey L. Delamater, Liberty Lake, WA (US); Arun Sehgal, Spokane, WA (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/828,710

(22) Filed: Jul. 26, 2007

Related U.S. Application Data
(60) Provisional application No. 60/833,350, filed on Jul. 26, 2006.

(51) Int. Cl. G08C 15/06; G08B 23/00

(52) U.S. Cl. 340/870.02

(57) ABSTRACT

A solution for providing various types of encoder-receiver-transmitter (ERT) devices for use in corresponding types of automatic meter reading (AMR) systems that receive standard consumption messages (SCMs) from ERT devices. According to one aspect, the solution includes maintaining a set of records that associate each issued serial number with a corresponding configured ERT type. A new first ERT device of a first type is configured with a serial number in accordance with the set of records. The first ERT device may have a common serial number with another ERT device of a different type; but the first ERT device may not have a common serial number with any other ERT device of the first type.

### CLAIM TO PRIORITY

This Application claims the benefit of U.S. Provisional Application No. 60/833,350, entitled “MANAGING SERIAL NUMBERING OF ENCODER-RECEIVER-TRANSMITTER DEVICES IN AUTOMATIC METER READING SYSTEMS,” filed Jul. 26, 2006, which is incorporated by reference herein in its entirety.

### FIELD OF THE INVENTION

The present invention relates generally to automatic utility meter reading (AMR) and, more particularly, to uniquely identifying individual utility meter encoder-receiver-transmitter (ERT) devices based on their message transmission while reusing serial numbers.

### BACKGROUND OF THE INVENTION

Automatic meter reading (AMR) systems are generally known in the art. Utility companies, for example, use AMR systems to read and monitor customer meters remotely, typically using radio frequency (RF) communication. AMR systems are favored by utility companies and others who use them because they increase the efficiency and accuracy of collecting readings and managing customer billing. For example, utilizing an AMR system for the monthly reading of residential gas, electric, or water meters eliminates the need for a utility employee to physically enter each residence or business where a meter is located to transcribe a meter reading by hand.

There are several different ways in which current AMR systems are configured. In a fixed network, such as described in U.S. Pat. No. 5,914,673 to Jennings et al., incorporated by reference herein in its entirety, encoder-receiver-transmitter (ERT) devices at meter locations communicate with readers that collect readings and data using RF communication. There may be multiple fixed intermediate readers located throughout a larger geographic area on utility poles, for example, with each ERT device associated with a particular reader and each reader in turn communicating with a central system. Other fixed systems utilize only one central reader with which all ERT devices communicate. In a mobile reader environment, a handheld or otherwise mobile reader with RF communication capabilities is used to collect data from ERT devices as the mobile reader is moved from place to place.

Typically, ERT-based AMR systems operate in the 915 MHz ISM band and utilize AM (such as on-off keying modulation). Basic ERT devices maintain a running counter that represents the amount of consumption of the metered utility, or commodity. ERTs can transmit information pertaining to the utility meter as a standard consumption message (SCM). Table 1 below describes the structure of an SCM packet used for communicating a single consumption reading and some associated data. One example of an ERT packet is described in detail in U.S. Pat. No. 4,799,059, which is incorporated by reference herein in its entirety.

TABLE 1
SCM Packet Format

| BIT Content | Number of Bits | Fixed Value |
|---|---|---|
| Sync Bit (MSB) | 1 | 1 |
| Preamble | 20 | 0xF2A60 |
| ERT ID MS Bits | 2 | — |
| Reserved * | 1 | — |
| Physical Tamper | 2 | — |
| ERT Type | 4 | — |
| Encoder Tamper | 2 | — |
| Consumption Data | 24 | — |
| ERT ID LS Bits | 24 | — |
| CRC Checksum (LSB) | 16 | — |

More advanced ERTs maintain consumption information as a function of time, such as over configured time intervals t_{Δ}. The t_{Δ}intervals are typically selected to be rather short, for example, 1.5, 2.5 or 5.0 minutes. This manner of data logging enables time of use and demand metering, as well as facilitating a way for utility providers to recognize the occurrence of supply problems such as outages. An interval data message (IDM) packet is used to transmit interval consumption data.

Table 2 below describes the structure of a typical IDM packet. Four bytes are reserved for the most recent consumption count, and 53 bytes are used for representing differential consumption values for 47 intervals (each represented by a 9-bit field).

TABLE 2
IDM Packet Format

| | Fixed | |
|---|---|---|
| | Number | |
| BIT Content | of Bytes | Fixed Value |
| Training Synchronization Sequence (MSB) | 2 | 0x5555 |
| Frame Synchronization Sequence | 2 | 0x16A3 |
| Packet Type ID | 1 | 0x1C |
| Total Packet Length | 2 | 0x5CC6 |
| Application Version | 1 | 0x01 |
| ERT Type | 1 | — |
| ERT Serial Number | 4 | — |
| Consumption Interval Counter | 1 | — |
| Module Programming State | 1 | — |
| Tamper Counters | 6 | — |
| Asynchronous Counters | 2 | — |
| Power Outage Flags | 6 | — |
| Last Consumption Count | 4 | — |
| Differential Consumption Intervals | 53 | — |
| Transmit Time Offset | 2 | — |
| Serial Number CRC | 2 | — |
| Packet CRC (LSB) | 2 | — |

While the IDM packet provides much more information-bearing capacity than the SCM packet, there remains a need for ERT devices to utilize the SCM format. One reason for this is that SCM packets, being about an order of magnitude shorter than an IDM message, require a correspondingly smaller amount of energy for their transmission. Thus, in battery-powered ERTs, transmitting lower-energy SCM packets substantially extends the battery life. Another benefit of transmitting SCM packets is they require less on-air time if transmitted at a similar data rate as IDM packets. Shorter transmissions are less likely to experience a collision, RF interference, or some other communication failure during the transmission.

Each ERT must be uniquely identifiable within a particular AMR system so that its originated information can be properly associated with its corresponding location and customer account for administrative and billing purposes. Existing ERTs have serial numbers assigned to them at the factory, and each ERT is configured to include its serial number as part of its SCM packet. The SCM packet has two fields assigned to this purpose: the 2-bit ERT ID MS (most significant) Bits field; and the 24-bit ERT ID LS (least significant) Bits field. Together, these fields contain a 26-bit binary representation of the ERT serial number. With 26 bits assigned to uniquely designate the ERT, the SCM format was designed to permit 2²⁶, or 67,108,864, unique devices.

In IDM packets, the ERT serial number is represented by a 4-byte (32 bit) field capable of representing 2³², or almost 5 billion unique devices. Thus, IDM packets are capable of uniquely identifying an ERT from among a substantially greater number of total units as compared with the 26-bit serial number field of the SCM packet.

Fixed and mobile AMR systems that employ the SCM format have become widespread. There are now over 65 million ERT devices in the field serving water, gas, and electrical metering applications. The quantity of ERT devices in the field is growing and approaching the limit of possible uniquely-identifiable units based on the 26-bit serial numbering scheme.

Changing the SCM format to accommodate longer serial numbers is not practical. Different types, models, and versions of AMR readers currently in service at different geographic locations and operated by different utility providers are configured to receive existing SCM packets from existing ERT devices. Utility providers need to continue using their existing ERT devices without re-configuring each individual installed device. A change in the SCM format would require a major AMR infrastructure overhaul effort at each utility provider, including hardware replacement in many cases, and would most likely involve creating a capability to distinguish between old-format and new-format SCM packets. Such a comprehensive overhaul program would be logistically challenging and not cost justified.

It would be desirable, therefore, to institute a system in which existing SCM packets effectively carry ERT identification information for uniquely identifying ERT modules from among a total number of ERT modules well in excess of the current limit of 67 million unique identification numbers.

### SUMMARY OF THE INVENTION

One aspect of the present invention is directed to uniquely recognizing a specific ERT, in an SCM-based AMR system. Upon receiving a SCM transmitted by one of a multitude of ERTs, a unique identity of the ERT is determined based on a numerical value having a length that is greater than 26 bits and that is defined by values of the first ERT ID field, the second ERT ID field, and at least a portion of a third field of the SCM, such as the ERT type field. This approach enables assigning unique identifiers to a plurality of new ERTs by reusing at least some of the values for the first ERT ID field and the second ERT ID field already assigned to others of the plurality of existing ERTs.

According to another aspect of the invention, various types of encoder-receiver-transmitter (ERT) devices for use in corresponding types of SCM-based AMR systems are provided by maintaining a set of records that associate each issued serial number with a corresponding configured ERT type. A first new ERT device of a first type is configured with a serial number in accordance with the set of records such that the first ERT device may have a common serial number with another ERT device of a different type, and the first ERT device may not have a common serial number with any other ERT device of the first type.

Another aspect of the invention is directed to issuing potentially non-unique serial numbers for assignment to various types of ERT devices. A plurality of records is maintained in a computer database, each record representing associations of previously-issued serial numbers and corresponding ERT types. A request for issuance of a serial number for use with a new ERT device is received over a computer network. Using a computer, a serial number is issued in response to the request such that the issued serial number is associated with a matched ERT type that is consistent with a type of the new ERT device. The associated serial number and the matched ERT type is distinct from any serial number-ERT type association of the plurality of records. The plurality of records is updated to reflect the issued serial number as associated with the matched ERT type.

### BRIEF DESCRIPTION OF THE DRAWINGS

FIG. 1A is a diagram illustrating an example of a conventional ERT-based AMR system arrangement.

FIG. 1B is a diagram illustrating the components of a conventional ERT device.

FIG. 2 is a diagram illustrating various types of conventional ERT-based AMR system receiver devices.

FIG. 3 is a diagram illustrating an example method of uniquely identifying an ERT based on separate ERT type and ERT serial number fields of an SCM packet according to one embodiment of the invention.

FIG. 4 is a diagram illustrating another example method of uniquely identifying an ERT by a collector/billing system in accordance with another embodiment of the invention.

FIG. 5 is a system block diagram illustrating an example arrangement for administering serial numbers in an AMR system according to one embodiment of the invention.

FIG. 6 is a flow diagram illustrating an example process of operation of the system of FIG. 5 according to one embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE PREFERRED EMBODIMENTS

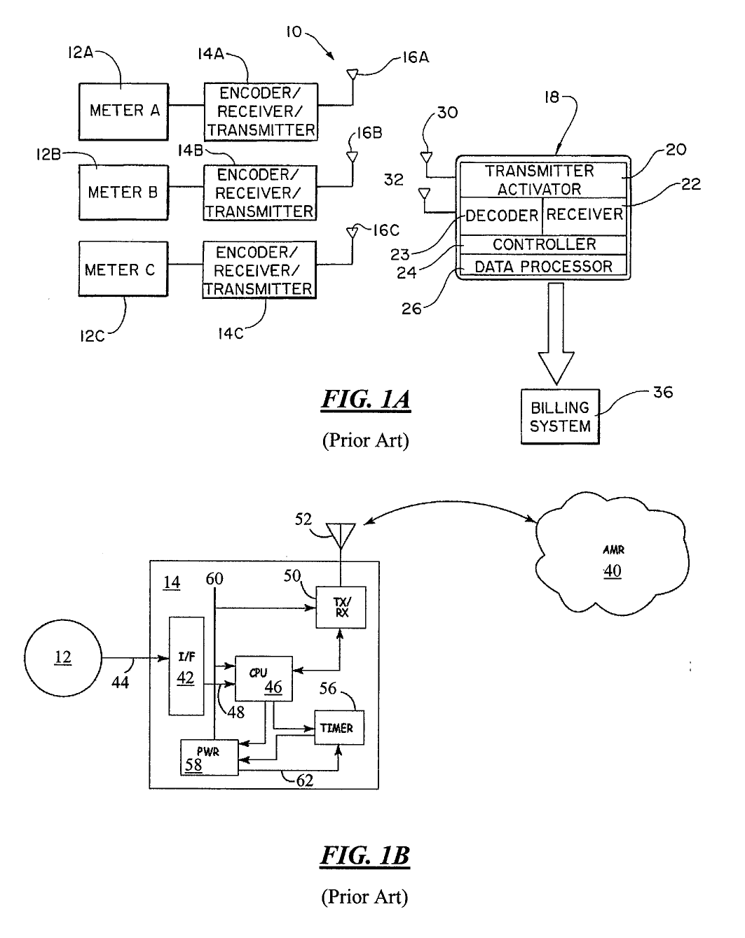

FIG. 1A is a diagram illustrating a portion of a typical automatic meter reading (AMR) system. As shown, automatic/remote AMR system 10 is adapted for use with a plurality of remotely located consumption sensing instruments such as meters 12A-12C. Meters 12A-12C sense or monitor a physical parameter, such as a quantity of a given commodity (e.g. electrical power, gas, water, network connection, etc.) used by a residential or business customer. The meters 12A-12C are also capable of sensing critical events, such as unauthorized tampering, certain malfunctions, and power outages (in the case where the meters 12A-12C sense are sensing electric power consumption).

Associated with and operatively coupled to each meter 12A-12C is an ERT 14A-14C (generally referred to as ERT 14). ERTs 14A-14C all function in a similar manner, and are typically identical to facilitate high volume, low cost construction. Each ERT 14 has a meter interface and a transponder and includes an antenna 16A-16C, respectively, for receiving and transmitting radio frequency (RF) signals as well as a processor, including a random access memory (RAM), an EEProm, and a simple power supply. Any of ERTs 14A-14C can be integral with their corresponding utility meter 12A-12C. ERTs 14A-14C accumulate and digitally store consumption data and critical events sensed by meters 12A-12C, respectively.

FIG. 1B illustrates in greater detail one embodiment of an ERT 14. ERT 14 interfaces with a utility meter 12, receives consumption and other relevant data from utility meter 12, and communicates the data to AMR system 40. ERT 14 includes an interface system 42, which operatively couples to utility meter 12 via coupling 44. In one embodiment, coupling 44 includes electrical and mechanical components for making a physical and electrical connection between utility meter 12 and ERT 14. For example, coupling 44 can include an encoder that converts the utility meter 12 measurement into a digital representation that is readable by a processor 46. Interface system 42 is interfaced with processor 46 via interface 48. In one embodiment, interface 48 includes a portion of a data bus and of an address bus.

In this example embodiment, processor 46 executes instructions that control the operation of ERT 14. In one embodiment, processor 46 includes a microprocessor-type system that has instruction, configuration, and scratchpad memory, an instruction processing core, and input/output circuits. Processor 46 interfaces with radio transceiver 50, which is then coupled to an antenna 52. In operation, interface hardware 42 forwards and converts utility meter data for further processing by processor 46. Processor 46 processes and stores the data at least temporarily, converts at least a portion of the utility meter or related data into SCM packets, and instructs transceiver 50 to communicate to AMR system 40 at appropriate times. Consumption data, as well as other account information such as identification data identifying utility meter 12 from which the consumption data was sensed, is encoded for transmission (i.e. packetized) in a RF ERT signal by processor 46 when ERT 14 is externally activated by AMR system 40 (e.g. polled) or self-activated (e.g. one-way bubble-up operation).

The unique identity of ERT 14 is maintained in a non-volatile memory device such as a ROM, EEPROM, battery-backed RAM, or the like. In one embodiment, the non-volatile memory device is a part of processor 46.

ERT 14 preferably operates in a low-power standby mode during a majority (>50%) of the time. While in the standby mode, interface system 42, processor 46, and transceiver 50 are effectively shut down or are operated in a low-power sleep mode to reduce power consumption. Timer 56 operates to periodically wake up the shut-down systems so that they enter into an active operating mode.

ERT 14 includes a power supply 58, which provides conditioned power to interface system 42, processor 46, and transceiver 50 via a power bus 60, and to timer 56 via a power line 62. In certain types of ERT devices, such as water or gas ERT types, power supply 58 includes one or more batteries. Once power is applied via power bus 60 to processor 46, interface system 42, and transceiver 50, processor 46 begins executing a program that gathers data from utility meter 12 via interface system 42, and momentarily activates transceiver 50.

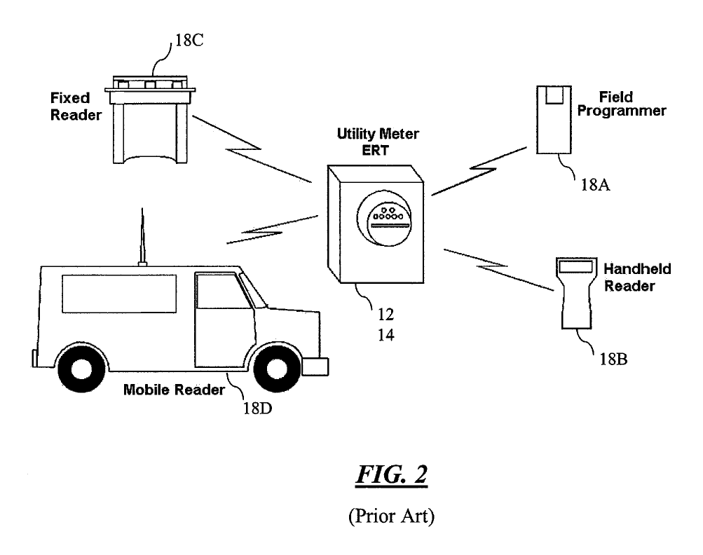

AMR system 10 also includes a reader 18 that receives consumption and related information from ERT devices 14A-14C. FIG. 2 illustrates various types of reader devices, including field programmer 18A, handheld mobile reader 18B, fixed reader 18C, and vehicle-based mobile reader 18D. Referring again for FIG. 1, an example reader 18 includes transmitter activator 20, and a receiver that includes radio receiver circuit 22, decoder 23, controller 24, and data processor 26. Transmitter activator 20 transmits RF activation signals to ERTs 14A-14C via antenna 30, while RF ERT signals from ERTs 14A-14C are received by radio receiver circuit through antenna 32.

One-way ERT devices bubble up according to a schedule to transmit their consumption and related information. One-and-a-half-way ERTs operate in a low-power receive mode that listens for activation signals from the AMR system, and respond to the activation signals by entering a high-power active operating mode transmitting their consumption and related information. Two-way ERTs can operate in either of these modes and, in addition, can respond to command and control instructions issued from the AMR system.

For communicating with one-and-a-half-way ERT devices, transmitter activator 20 of reader 18 generates a polling or activation signal which is transmitted through antenna 30. All ERTs 14A-14C within range of transmitter activator 30 will respond upon receipt of the activation signal through their antennas 16A-16C. Once activated, ERTs 14A-14C produce and transmit their RF ERT signals which includes the consumption and identification data according to an SCM or IDM format, depending on the ERT configuration.

In a two-way operation embodiment, reader 18 individually addresses a specific ERT 14 by broadcasting a command and control or a suitable prompting message packet that includes the specific ERT's unique identity. When the individually-addressed ERT device receives the prompting message, it responds according to the instructions contained therein.

Some ERT devices transmit only SCM packets, while others transmit only IDM packets. Other types of ERT devices can transmit either type of packet, depending on certain conditions. For example, the prompting signal can explicitly or implicitly request a certain type of response from the ERT. In another example embodiment, an ERT transmits either an SCM packet or an IDM packet depending on some known condition, such as the time of day, day of the month, time elapsed since the last read, or some other predetermined condition.

Each transmitted ERT radio packet is received by radio receiver circuit 22, and the data contained therein is decoded by decoder 23 to convert the received data into a form readable by data processor 26. This data is then further processed and stored by data processor 26 under the control of controller 24. Based on the type of receiver device 18, the consumption, identification, account information, and other consumption and related information is transferred to a utility billing system 36. This transfer can take place very soon after receipt of the ERT packet (such as where the receiver device 18 operates as a repeater), or later (such as where the reader 18 operates as a data collection and storage device).

Serial Number Management

As described above with reference to Table 1, the existing SCM packet uses two separate (non-contiguous) fields, the 2-bit ERT ID MS Bits field; and the 24-bit ERT ID LS Bits field, for communicating the identification of the ERT. According to one aspect of the present invention, the unique identification of each ERT is expanded beyond the presently-used 26 bits. In one embodiment, the SCM packet will communicate the unique identity of its originating ERT device by the two ERT ID fields together with at least a portion of a third field. In one embodiment, the portion of, or the entire third field will serve a dual purpose in representing a part of the ERT's unique ID, as well as representing all or a corresponding portion of the information assigned to the third field.

The format in which the ERT identity is stored in the device can take any suitable form. For example, the ERT identity can be in the form of a n-bit serial number in contiguous memory space. In another embodiment, the identity of the ERT device is stored among two or more non-contiguous spaces in the non-volatile memory. In one embodiment, an ERT device is configured with a unique ID (greater than 26 bits) in one or more non-volatile memory spaces, and the processor (such as processor 46) constructs the SCM packet for transmission based in part on the unique ID read from the one or more non-volatile memory spaces.

Traditionally, when ERT devices have been manufactured, each individual device has been configured with its assigned ERT identity. ERT devices have been assigned serial numbers in a generally sequential fashion without regard to the type of ERT. Thus, for example, a gas ERT can have a first serial number, a water ERT can have the next sequential serial number, etc. This practice resulted in distributing serial numbers across different types and models of ERT devices without any defined type-based grouping. Based on these facts, one aspect of the invention recognizes that ERT devices can be uniquely identified even when the 26-bit ERT ID information is duplicated for more than one ERT, provided that the ERT ID duplication occurs only for different ERT types. In one embodiment of the invention, the third field used for representing ERT ID information is the 4-bit Type field of the SCM packet.

According to this embodiment, AMR system readers (such as reader 18) or collection and billing systems (such as billing system 36), collectively, the AMR collection infrastructure, identifies the originating ERT of a particular received SCM packet based on the ERT type indicated in the SCM packet, together with the 26-bit ERT ID information from the two ERT ID fields of the SCM packet. This can be accomplished by a variety of ways within the spirit of the invention, some of which are illustratively described below.

According to one example of an AMR system embodying this aspect of the invention, the AMR system handles the ERT type information from the ERT type field of the SCM packet separately from the serial number information in the two SCM ERT ID fields. The ERT ID information, and the serial number, are each passed to the collection and billing system via the SCM message read. The collection and billing system then uses these two separate units of information to uniquely identify the ERT among other ERT devices having the same ERT type or having the same ERT serial number.

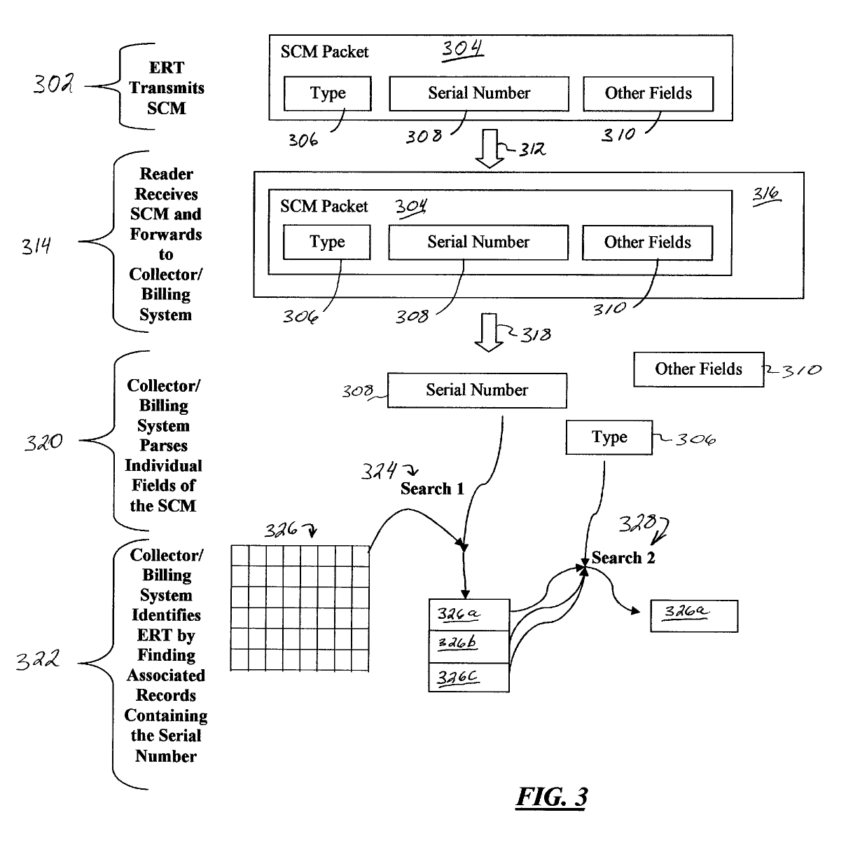

FIG. 3 illustrates an example method of uniquely identifying an ERT based on separate ERT type and ERT serial number fields of an SCM packet. At step 302, an ERT device generates and transmits SCM packet 304. SCM packet 304 contains an ERT type field 306 and ERT serial number information contained in the ERT ID MSB and the ERT ID LSB fields as described above. For illustrative purposes, the ERT serial number fields are collectively depicted in FIG. 3 as serial number fields 308. SCM packet 304 also contains the other SCM fields, collectively depicted as other fields 31O. The SCM packet 304 is transmitted for reception by an AMR reader, as indicated at 312.

At step 314, the reader receives SCM packet 304. In one embodiment, as depicted, the reader re-packages SCM packet 304 into a reader packet 316, optionally together with other SCM packets from other ERT devices (not shown), or with additional information about the reader. As indicated at 318, the reader forwards the packet to a collector/billing system.

At step 320, the collector/billing system parses out the fields of interest for each received SCM packet, and utilizes the information in the serial number fields 308 and ERT type field 306 to access the database record associated with the ERT that generated SCM packet 304. To access the correct record, at step 322, the collector/billing system executes a first search 324 to look up any records associated with the serial number contained in serial number fields 308 from among all records 326. The first search can potentially return a plurality of records, such as records 326a, 326b, and 326c. Next, the collector/billing system executes a second search 328 to identify any records from among records 326a, 326b, and 326c that are also associated with the ERT type represented by ERT type field 306. This second search will return up to one record associated with the specific ERT that generated SCM packet 304.

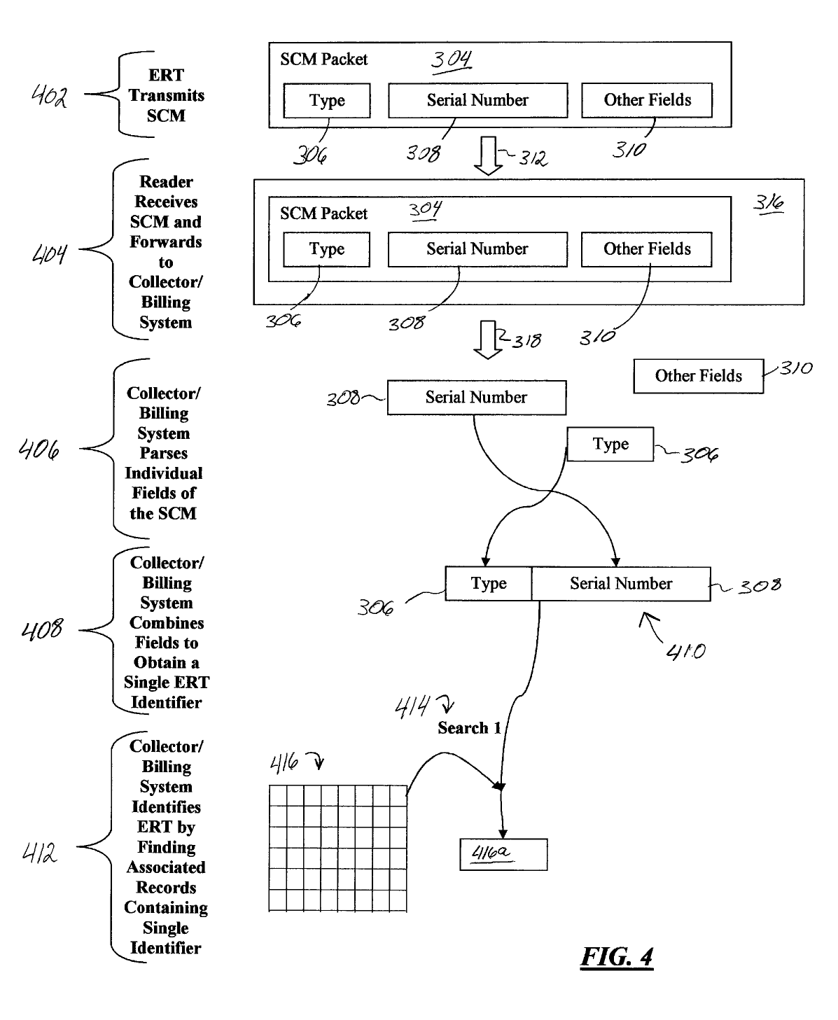

According to another example of an AMR system according to an alternative embodiment, an extended serial number is defined based on the ERT type and the two ERT ID fields. This extended serial number can be configured in an ERT device, or it can be compiled by a reader, a data collector, or a billing system. FIG. 4 illustrates the operation of a collector/billing system in accordance with this embodiment. Steps 402, 404, and 406 are similar, respectively, to steps 302, 314, and 320 described above with reference to FIG. 3. At step 402, SCM packet 304 is generated and transmitted by an ERT device. At step 404 SCM packet 304 is received, optionally re-packaged into reader packet 316, and transmitted to the AMR system collector/billing system. At step 406, the collector/billing system parses out the fields of interest.

At step 408, the collector/billing system combines the ERT type field 306 with serial number fields 410 in some manner (such as, for example, by concatenating the fields) to form an extended serial number 410. At step 412, the collector/billing system executes a search 414 among all database records 416 for a record associated with extended serial number 410. Search 414 should produce, at most, one record, such as the record indicated at 416a in FIG. 4.

As a variation of the example operation depicted in FIG. 4, extended serial number 410 can be generated elsewhere in the AMR system. For example, in one embodiment, extended serial number 410 is generated at the reader. In another example embodiment, extended serial number 410 is defined at the ERT, which generates the SCM packet with fields 306 and 308 representing extended serial number 410 and, in turn, the reader or collector/billing system re-constructs extended serial number 410 after the SCM packet is received.

Extended serial number 410 can, in a sense, be considered as a virtualized ERT identifier. The virtualized ERT identifier is associated with the 26-bit base serial number and the ERT type indicator according to some predefined relationship such as a formula or lookup table. In one such embodiment, the ERT type (in decimal form) is concatenated to the beginning or end of the base serial number represented by the two ERT ID fields of the SCM message (in decimal form). For example, a device type 02 ERT with a base serial number of 00034051 would have an extended serial number of 0200034051. This extended serial number can be used by the billing system, for example, as a single unit of information for uniquely identifying the ERT, as described in FIG. 4. For simplifying human interface with the ERT devices, such as configuration or troubleshooting purposes, the extended serial number as a concatenation of ERT type and base serial number can have the same decimal digits that are printed on a label or nameplate affixed to the exterior of each ERT.

In another embodiment, the extended serial number that is a concatenation of the ERT type and the base serial number (such as extended serial number 410) can be a concatenation of the binary representations of the ERT type and base serial number, respectively. This type of arrangement will result in a decimal representation that is different than a concatenation of the respective decimal representations of the ERT type and base serial number.

In another embodiment, the extended serial number is defined as a virtualized ERT identifier based on a formulaic incorporation of the ERT type indicator and the base serial number. For example, a 32-bit extended serial number to represent the ERT type in combination with the 26-bit base serial number can be defined according to Formula (1) for a decimal representation and according to equivalent Formula (2) for a hexadecimal representation as follows:
100000000*ERT Type+ERT Base Serial Number (1)
4000000(Hex)*ERT Type (Hex)+ERT Base Serial Number (Hex) (2)

Formulas (1) and (2) achieve virtualized serial numbers that read like a concatenation of the ERT type, followed by the base serial number in decimal form and in binary form, respectively. Table 3 below illustrates an example set of virtualized ERT ID ranges in decimal form for different ERT types manufactured by Itron Inc. of Spokane, Wash.

TABLE 3
Examples of Virtualized ERT ID Ranges

| | ERT Type Value | Virtualized 32 ERT ID |
|---|---|---|
| ERT Type Description | (Decimal) | Range (Decimal) |
| 25 GD1 (Gas) SCM | 0 | 0 to 67108863 |
| 25 GD2 (Gas) SCM | 1 | 100000000 to 167108863 |
| 40 G (Gas) SCM | 2 | 200000000 to 267108863 |
| 40 W, 50 W (Water) SCM | 3 | 300000000 to 367108863 |
| 40 EOEM (Electric) SCM | 4 | 400000000 to 467108863 |
| 40E, 40ER-1, 40EN, 41-ER (SCM) | 5 | 500000000 to 567108863 |
| (Electric) | | |
| Repeater SCM Status Message | 10 | 1000000000 to 1067108863 |
| 45 ERT SCM/IDM, 51ESS SCM/IDM | 7/23, 25 | 2300000000 to 2367108863 |
| (Electric), R300 SCM/IDM, IDM | | |
| w/variable length and message | | |
| numbering(Type 25) Messages | | |
| 50ESS SCM/IDM (Electric), R300 | 8/24, 25 | 2400000000 to 2467108863 |
| SCM/IDM, IDM w/variable length and | | |
| message numbering (Type 25) Messages | | |

Presently, reader units, such as interrogator reader 18, can recognize either SCM packets or IDM packets, or both. An ERT device according to one type of embodiment can work with SCM-only readers and IDM-only readers based on its configuration. In this type of embodiment, the ERT can have a different unique identifier for SCM packets than for IDM packets.

In another ERT embodiment, to facilitate system upgradeability or changeover from SCM packets to IDM or IDM-style packets having longer ERT ID fields than SCM packets, or to support an AMR system that utilizes both, SCM, and IDM-style packets, each ERT device indicates the same identity regardless of the message type. For this purpose, in a related embodiment, the ERT can include a suitable combination of the ERT type indicator and the base serial number of the SCM packet, such as a binary concatenation of these two identity elements, a binary representation of a decimal concatenation of the two identity elements, or any other generated value based on applying some rule in the longer “serial number” field of the ERT device's IDM message. Compatible AMR system components that need to identify ERT devices are configured with an inverse operation that applies the same rule for recognizing the ERT based on its SCM packet or on its IDM packet.

In one embodiment, when an AMR system collector or billing system receives an SCM packet and determines the ID number of the ERT device that originated the SCM packet, the collector/billing system determines the full identity of the ERT by looking up information related to the ERT ID number, such as, for example, a billing system account record, a postal address, or the like.

According to another aspect of the invention, already-issued and available ERT serial numbers are managed in a way that facilitates issuing duplicative 26-bit serial numbers for new ERT devices while permitting ERT devices to be uniquely identified. In one type of embodiment, the serial number management can be administered to enable ERT configurors to obtain ERT serial numbers for configuring new ERT devices for use in existing or compatible ERT-based AMR systems while ensuring an ability to uniquely identify each ERT device.

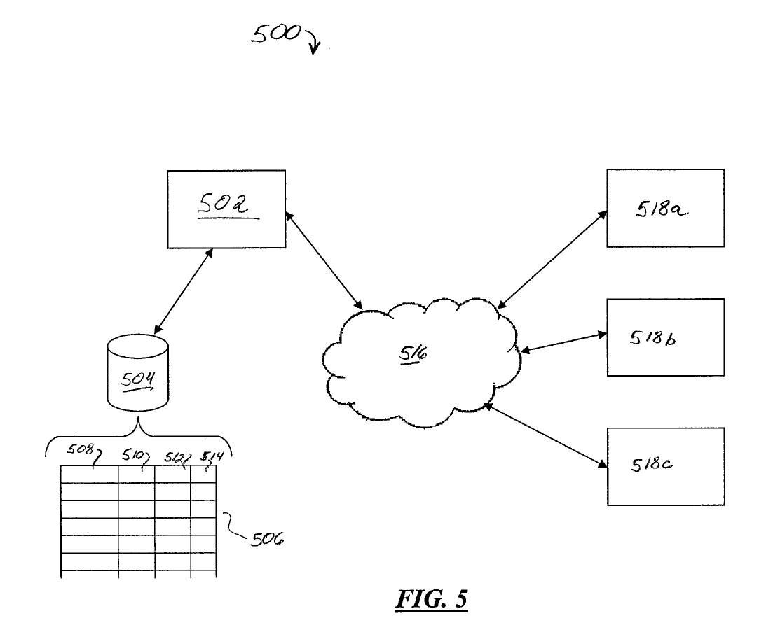

FIG. 5 illustrates an arrangement of an example system 500 for administering serial numbers in an AMR system such as the example systems described above that uses the ERT type together with the ERT base serial number transmitted in the SCM packet to uniquely identify the ERT originating the SCM packet. System 500 includes a serial number authority 502 that manages recordkeeping and issuance of ERT serial numbers. The recordkeeping function is facilitated by a serial number database 504. Serial number database 504 stores records 506 of previously-issued ERT serial numbers. Each record 506 includes at least the 26-bit serial number 508, and an associated ERT type 510. Each record of records 506 can also include the name or ID of the AMR system operating utility 512, and the name or ID of the manufacturer of the ERT associated with the particular record.

Serial number authority 502 can read and update records 506 of database 504. In various embodiments, database 504 can be a centralized or a distributed database. Also, there can be more than one serial number authority (not shown) that accesses database 504. Serial number authority 502 can be a manufacturer of ERT devices, or can be a separate entity. In one embodiment, serial number authority is implemented as an application program that runs on a computer having a programmable processor operatively coupled to a computer network interface. System 500 illustrates one such embodiment, in which serial number authority 502 is communicatively coupled with computer network 516. In one embodiment, computer network 516 is the Internet. In another embodiment computer network 516 is a private intranet.

ERT configurors 518a, 518b, and 518c (collectively referred to as ERT configurors 518) are each communicatively coupled to computer network 516, and are each generally authorized to engage in information exchange with serial number authority 502. In one embodiment of system 500, ERT configurors 518 are different manufacturers, distributors, repair centers, or operators of ERT devices. In another embodiment, ERT configurors 518 are different units of manufacturing or test equipment at a single ERT manufacturer. In other embodiments, configurors 518 are different units of ERT configuration equipment at potentially different ERT manufacturers, distributors, repair centers, AMR system operators, or the like. Persons skilled in the art will appreciate that ERT configurors within the spirit of the invention include any person, entity, or machine that configures or re-configures an ERT device with a serial number.

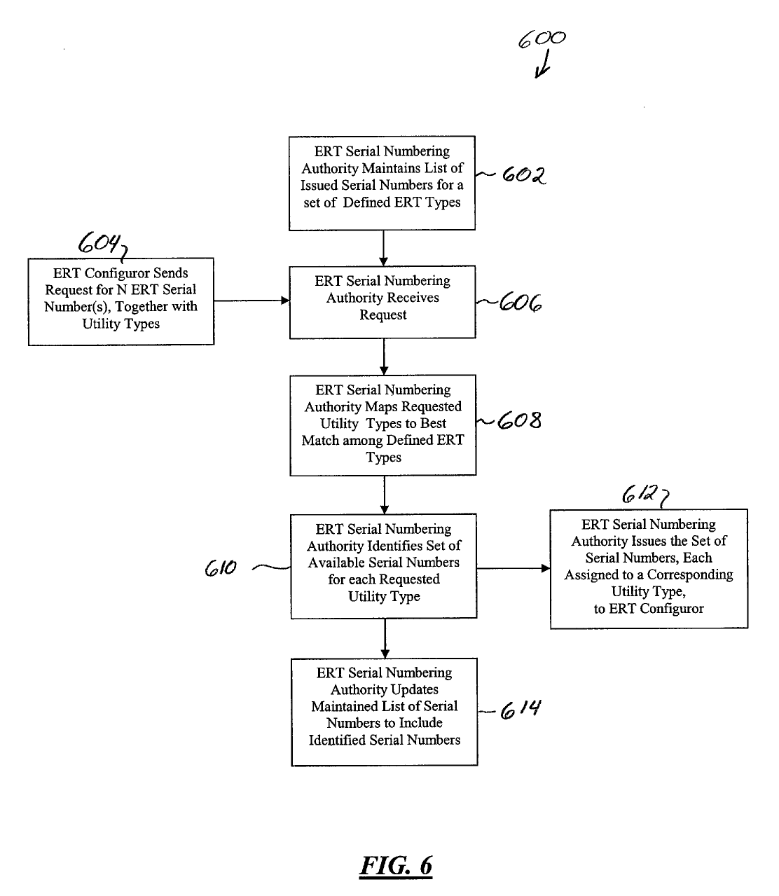

ERT configurors 518 rely on serial number authority 502 to issue appropriate serial numbers. In one type of embodiment, issuance of new serial numbers is associated with a sale, lease, servicing, or licensing transaction, or with a combination thereof. FIG. 6 illustrates an example process 600 by which system 500 can operate according to one embodiment. As indicated at 602, serial number authority 502 maintains records 506 in database 504. At step 604, an ERT configuror, such as ERT configuror 518a, sends a request for one or more (N quantity) ERT serial numbers. The request includes the type(s) of ERT devices with which the serial number(s) are to be associated.

In some instances, the requesting ERT configuror does not know the correct ERT type. In such a case, the request can include the type or a description of the utility service for which the ERT device will be utilized. For example, the request can include the information items presented in Table 4 below:

TABLE 4
Examples of a Request for Issuance of Serial Numbers
Requestor ID

| | ERT Type | Quantity of Serial Numbers |
|---|---|---|
| Utility Type/Description | (Decimal) | Requested |
| Gas | 0 | 23 |
| Water | | 51 |
| Electric | 24 | 70 |

The request can be accompanied by a purchase order, assent to contractual terms via click-wrap agreement, or any other such item necessary for completing the transaction. At step 606, serial number authority 502 receives the request via a suitable computer network interface, such as a secure server. At step 608, serial number authority 502 maps the requested ERT type or the requested ERT type description to a defined ERT type. Step 608 can include cross-checking the request for internal consistency (such as, for example, if the request specifies an incorrect ERT type for a particular utility type. Step 608 can facilitate determining the appropriate ERT type from the set of defined ERT types based on a specified utility description of the request.

At step 610, based on the request, serial number authority 502 checks database 504, and identifies a set of available serial numbers with associated ERT types that can be issued. Serial numbers that are duplicative with respect to previously-issued serial numbers are nevertheless deemed available if they are associated with a different ERT type.

An issuable serial number can be generated based on a predetermined serial number sequencing protocol, or according to any suitable rule set. In one embodiment, serial number authority 502 selects an existing serial number for a particular ERT type from among previously issued serial numbers associated with different ERT types. In a related embodiment, serial number authority 502 pre-issues blocks of serial numbers for predefined ERT types, and generates serial number-ERT type matched sets in response to requests by selecting from among the pre-issued blocks of serial numbers.

At step 612, serial number authority 502 issues a matched set of a serial number and its associated ERT type, and transmits the issuance with reference to the request to the ERT configuror via the computer network 516. At 614, serial number authority 502 updates database 504 to reflect the issued serial numbers accordingly.

The present invention may be embodied in other specific forms without departing from the spirit of the essential attributes thereof, therefore, the illustrated embodiments should be considered in all respects as illustrative and not restrictive, reference being made to the appended claims rather than to the foregoing description to indicate the scope of the invention.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. For an encoder-receiver-transmitter (ERT)-based automatic meter reading (AMR) system having a multitude of ERTs, a method of facilitating unique recognition of a specific ERT, the method comprising:
providing an AMR collection infrastructure device configured to:
receive a standard consumption message (SCM) transmitted by one of the multitude of ERTs, the SCM consisting essentially of a bit sequence arranged as: a 1-bit synchronization field, a 20-bit preamble field, a 2-bit first ERT ID field, a 1-bit special use field, a 2-bit physical tamper field, a 4-bit ERT type field, a 2-bit encoder tamper field, a 24-bit consumption data field, a 24-bit second ERT ID field, and a 16-bit validation field; and
determine a unique identity of one of the multitude of ERTs based on a numerical value having a length that is greater than 26 bits and that is defined by values of the first ERT ID field, the second ERT ID field, and at least a portion of a third field of the SCM.

2. The method of claim 1, wherein the third field used to determine of the unique identity is the ERT type field.

3. The method of claim 1, wherein providing the AMR collection infrastructure device includes configuring the device to concatenate the values of the first ERT ID field, the second ERT ID field, and at least the portion of the third field to produce a continuous sequence of bits uniquely identifying the ERT.

4. The method of claim 1, wherein providing the AMR collection infrastructure device includes configuring the device to concatenate values contained in the first ERT ID field and in the second ERT ID field to achieve a base value, and adding a modifier to the base value that is a multiple of the value of at least the portion of the third field.

5. The method of claim 1, wherein providing the AMR collection infrastructure device includes configuring the device to generate a virtualized ERT serial number for the ERT based on values of the first ERT ID field, the second ERT ID field, and at least the portion of the third field.

6. The method of claim 1, wherein providing the AMR collection infrastructure device includes configuring the device to look up at least one of: a billing system account record, and a postal address, wherein each is associated with the values read from the first ERT ID field, the second ERT ID field, and at least the portion of the third field.

7. The method of claim 1, wherein providing the AMR collection infrastructure device includes configuring the device to convert a combination of the values read from the first ERT ID field, the second ERT ID field, and at least the portion of the third field into a 32-bit ERT serial number.

8. The method of claim 1, wherein the multitude of ERTs includes a plurality of existing ERTs already deployed for a utility provider and a plurality of new ERTs to be deployed for the utility provider, and wherein the method further comprises:
assigning unique identifiers for the plurality of new ERTs by reusing at least some of the values for the first ERT ID field and the second ERT ID field already assigned to ones of the plurality of existing ERTs and assigning values for at least the portion of the third field that are different than values for at least the portion of the third field for the plurality of existing ERTs.

9. The method of claim 1, wherein providing the AMR collection infrastructure device includes configuring the device to determine the unique identity that is a serial number defined formulaically based on the value of the first ERT ID field, the value of the second ERT ID field, and the value of at least the portion of the third field.

10. The method of claim 9, wherein providing the AMR collection infrastructure device includes configuring the device to obtain the serial number by a process of concatenating the first ERT ID field and the second ERT ID field to achieve a base value, and adding a modifier to the base value that is a multiple of the value of at least the portion of the third field.

11. The method of claim 1, further comprising:
receiving an interval data message (IDM) transmitted by one of the multitude of ERTs, wherein the IDM includes:
a frame synchronization sequence consisting of the bit sequence 0x16A3; and
a 32-bit ERT serial number field that represents the unique ERT identification, wherein a value of the 32-bit ERT serial number field matches the unique identity of one of the multitude of ERTs.

12. A method of providing various types of encoder-receiver-transmitter (ERT) devices for use in corresponding types of automatic meter reading (AMR) systems that receive standard consumption messages (SCMs) from ERT devices, each SCM consisting essentially of a bit sequence arranged as: a 1-bit synchronization field, a 20-bit preamble field, a 2-bit first ERT ID field, a 1-bit special use field, a 2-bit physical tamper field, a 4-bit ERT type field, a 2-bit encoder tamper field, a 24-bit consumption data field, a 24-bit second ERT ID field, and a 16-bit validation field, wherein each ERT device is configured with (a) an issued serial number to represented by values of the 2-bit first ERT ID field and the 24-bit second ERT ID field of SCMs generated by the ERT device, and (b) an ERT type to be represented by a value of the 4-bit ERT type field of the SCMs generated by the ERT device, the method comprising:
maintaining a set of records that associate each issued serial number with a corresponding configured ERT type; and
configuring a first new ERT device of a first type with a serial number in accordance with the set of records such that:
the first ERT device may have a common serial number with another ERT device of a different type; and
the first ERT device may not have a common serial number with any other ERT device of the first type.

13. The method of claim 12, further comprising:
providing an AMR collection infrastructure device configured to:
receive a SCM transmitted by any one of the ERT devices; and
determine a unique identity of one of the multitude of ERTs based on a numerical value having a length that is greater than 26 bits and that is defined by values of the first ERT ID field, the second ERT ID field, and at least a portion of a third field of the SCM.

14. A method of issuing potentially non-unique serial numbers for assignment to various types of encoder-receiver-transmitter (ERT) devices for use in automatic meter reading (AMR) systems that receive standard consumption messages (SCMs) from ERT devices such that each issued ERT device can be uniquely identified based on its SCM message, each SCM consisting essentially of a bit sequence arranged as: a 1-bit synchronization field, a 20-bit preamble field, a 2-bit first ERT ID field, a 1-bit special use field, a 2-bit physical tamper field, a 4-bit ERT type field, a 2-bit encoder tamper field, a 24-bit consumption data field, a 24-bit second ERT ID field, and a 16-bit validation field, the method comprising:
maintaining a plurality of records in a computer database, each record representing associations of previously-issued serial numbers and corresponding ERT types; and
receiving, over a computer network, a request for issuance of a serial number for use with a new ERT device;
using a computer to issue a serial number in response to the request such that the serial number is associated with a matched ERT type that is consistent with a type of the new ERT device, wherein the associated serial number and the matched ERT type is distinct from any serial number-ERT type association of the plurality of records; and
updating the plurality of records to reflect the issued serial number as being associated with the matched ERT type.

15. The method of claim 14, wherein the receiving of the request includes receiving type-related information describing the new ERT device; and
wherein the assigning of the serial number includes mapping the type-related information to a predefined ERT type.

16. The method of claim 14, wherein generating of the serial number includes selecting a previously-issued serial number from among the plurality of records.

17. The method of claim 14, further comprising pre-issuing the sets of serial numbers matched with ERT types; and
wherein the assigning of the serial number in response to the request includes selecting a matched serial number-ERT type set from the pre-issued sets.

18. An encoder-receiver-transmitter (ERT)-based automatic meter reading (AMR) system comprising:
a plurality of ERTs operatively coupled to respective utility metering devices; and
an AMR collection infrastructure including at least one of a reader, a collection system, and a billing system, the AMR collection infrastructure adapted to be communicatively coupled with each of the plurality of ERTs;
wherein each of the plurality of ERTs transmits a standard consumption message (SCM), the SCM consisting essentially of a bit sequence arranged as: a 1-bit synchronization field, a 20-bit preamble field, a 2-bit first ERT ID field, a 1-bit special use field, a 2-bit physical tamper field, a 4-bit ERT type field, a 2-bit encoder tamper field, a 24-bit consumption data field, a 24-bit second ERT ID field, and a 16-bit validation field; and
wherein the AMR collection infrastructure determines a unique identity of one of the plurality of ERTs based on a numerical value having a length that is greater than 26 bits and that is defined by values of the first ERT ID field, the second ERT ID field, and at least a portion of a third field of the SCM.

19. The AMR system of claim 18, wherein the third field used in the determining of the unique identity is the ERT type field.

20. The AMR system of claim 18, wherein the AMR collection infrastructure is programmed to concatenate values contained in the first ERT ID field, the second ERT ID field, and at least the portion of the third field to produce a continuous sequence of bits uniquely identifying the ERT.

21. The AMR system of claim 18, wherein the AMR collection infrastructure is programmed to concatenate values contained in the first ERT ID field and in the second ERT ID field to achieve a base value, and add a modifier to the base value that is a multiple of the value of at least the portion of the third field.

22. The AMR system of claim 18, wherein the AMR collection infrastructure is programmed to generate a virtualized ERT serial number for the ERT based on values of the first ERT ID field, the second ERT ID field, and at least the portion of the third field.

23. The AMR system of claim 18, AMR collection infrastructure is programmed to look up at least one of: a billing system account record, and a postal address, wherein each is associated with the values read from the first ERT ID field, the second ERT ID field, and at least the portion of the third field.

24. The AMR system of claim 18, wherein the AMR collection infrastructure is programmed to convert a combination of the values read from the first ERT ID field, the second ERT ID field, and at least the portion of the third field into a 32-bit ERT serial number.

25. The AMR system of claim 18, wherein the plurality of ERTs includes a plurality of existing ERTs already deployed for a utility provider and a plurality of new ERTs to be deployed for the utility provider, and wherein the AMR collection infrastructure is programmed to:
assign unique identifiers for the plurality of new ERTs by reusing at least some of the values for the first ERT ID field and the second ERT ID field already assigned to ones of the plurality of existing ERTs and assigning values for at least the portion of the third field that are different than values for at least the portion of the third field for the plurality of existing ERTs.

26. The AMR system of claim 18, wherein the unique identity determined by the AMR collection infrastructure is a serial number defined formulaically based on the value of the first ERT ID field, the value of the second ERT ID field, and the value of at least the portion of the third field.

27. The method of claim 26, wherein the serial number defined formulaically is obtained by a process of concatenating the first ERT ID field and the second ERT ID field to achieve a base value, and adding a modifier to the base value that is a multiple of the value of at least the portion of the third field.

28. The AMR system of claim 18, wherein the AMR collection infrastructure is programmed to:
receive an interval data message (IDM) transmitted by one of the plurality of ERTs, wherein the IDM includes:
a frame synchronization sequence consisting of the bit sequence b 0x16A3; and
a 32-bit ERT serial number field that represents the unique ERT identification, wherein a value of the 32-bit ERT serial number field matches the unique identity of one of the plurality of ERTs.

29. A system for issuing potentially non-unique serial numbers for assignment to various types of encoder-receiver-transmitter (ERT) devices for use in automatic meter reading (AMR) systems that receive standard consumption messages (SCMs) from ERT devices such that each issued ERT device can be uniquely identified based on its SCM message, each SCM consisting essentially of a bit sequence arranged as: a 1-bit synchronization field, a 20-bit preamble field, a 2-bit first ERT ID field, a 1-bit special use field, a 2-bit physical tamper field, a 4-bit ERT type field, a 2-bit encoder tamper field, a 24-bit consumption data field, a 24-bit second ERT ID field, and a 16-bit validation field, the system comprising:
a computer database containing a plurality of records, each record representing associations of previously-issued serial numbers and corresponding ERT types; and
a computer network interface that receives a request for issuance of a serial number for use with a new ERT device;
a computer processor operatively coupled with the computer database and the computer network interface, and programmed to:
issue a serial number in response to the request such that the serial number is associated with a matched ERT type that is consistent with a type of the new ERT device, wherein the associated serial number and the matched ERT type is distinct from any serial number-ERT type association of the plurality of records;
and
update the plurality of records to reflect the issued serial number as being associated with the matched ERT type.

30. A system for providing various types of encoder-receiver-transmitter (ERT) devices for use in corresponding types of automatic meter reading (AMR) systems that receive standard consumption messages (SCMs) from ERT devices, each SCM consisting essentially of a bit sequence arranged as: a 1-bit synchronization field, a 20-bit preamble field, a 2-bit first ERT ID field, a 1-bit special use field, a 2-bit physical tamper field, a 4-bit ERT type field, a 2-bit encoder tamper field, a 24-bit consumption data field, a 24-bit second ERT ID field, and a 16-bit validation field, wherein each ERT device is configured with (a) an issued serial number to represented by values of the 2-bit first ERT ID field and the 24-bit second ERT ID field of SCMs generated by the ERT device, and (b) an ERT type to be represented by a value of the 4-bit ERT type field of the SCMs generated by the ERT device, the system comprising a processor operatively coupled with a data store, wherein:
the data store contains a set of records that associate each issued serial number with a corresponding configured ERT type; and
the processor that associates a first new ERT device of a first type with a serial number in accordance with the set of records such that:
the first ERT device may have a common serial number with another ERT device of a different type; and
the first ERT device may not have a common serial number with any other ERT device of the first type.
